(19) United States
(12) Patent Application Publication
(10) Pub. No.: US 2026/0222107 A1
(43) Pub. Date: Jul. 30, 2026

(54) DETERMINING A NUMBER OF SEGEMENTS BASED ON RETRANSMISSIONS TO MEET A PACKET DELAY REQUIREMENT IN A NETWORK NODE AND METHOD IN A WIRELESS COMMUNICATIONS NETWORK

(71) Applicant: Telefonaktiebolaget LM Ericsson (publ), Stockholm (SE)

(72) Inventors: Anders FURUSKÄR, Stockholm (SE); Jialu LUN, Solna (SE); Birgitta OLIN, Bromma (SE); Antzela KOSTA, Solna (SE); Panagiota LIOLIOU, Sundbyberg (SE); Ying SUN, Taby (SE); Oskar DRUGGE, Hjarup (SE)

(21) Appl. No.: 19/141,876

(22) PCT Filed: Dec. 21, 2023
(86) PCT No.: PCT/EP2023/087189

§ 371 Date: Jun. 20, 2025

(30) Foreign Application Priority Data
Dec. 22, 2022 (GR) 20220101068

(51) Int. Cl. H04L 1/00; H04L 1/1867

(52) U.S. Cl. CPC H04L 1/0017; H04L 1/0007; H04L 1/1867

(57) ABSTRACT

A method performed by a network node is provided. The method is for selecting a number of segments to segment an application data packet. The application data packet is to be transmitted between the network node and a User Equipment, UE, in a wireless communications network. The network node determines (201) a set of possible number of segments. The set of possible number of segments fulfils an application packet delay requirement with a certain probability. Each of the possible numbers of segments corresponds to a different number of retransmissions per segment. For each possible number of segments in the set, the network node determines (202) any one out of: an amount of data in a segment, or a segment data rate. For each possible number of segments in the set, the network node determines (203) a residual segment error probability after the possible number of retransmissions per segment, required to achieve the certain probability to meet the application data packet delay requirement. The network node determines (204) a signal quality requirement for each of the possible number of segments, based on: the amount of data in a segment, or the segment data rate, a number of allowed retransmissions per segment, and the residual segment error probability. The network node then selects (205) the number of segments that fulfills a criterion related to the determined signal quality. The number of segments that fulfils a criterion is selected from the determined set of possible numbers of segments. The determined number of segments will be used to segment the application data packet to be transmitted between the network node and the UE.

### TECHNICAL FIELD

Embodiments herein relate to a network node and a methods therein. In some aspects, they relate to selecting a number of segments to segment an application data packet to be transmitted between the network node and a User Equipment (UE) in a wireless communications network.

### BACKGROUND

In a typical wireless communication network, such as e.g. a mobile network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5GC is core network, NR is radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

Many services have delay requirements on application packet level, meaning that an application packet, e.g. a voice or video frame, needs to be delivered within a certain delay budget for satisfactory user experience.

In a radio network, for transmission over the radio interface, application packets are often segmented into smaller units of data, here simply denoted ‘segments’, these segments may correspond e.g. to Transport Blocks (TB) s in certain protocols. To meet an application packet delay requirement, all segments need to be delivered within the delay budget.

### SUMMARY

As a part of developing embodiments herein a problem was identified by the inventors and will first be discussed.

To increase efficiency and robustness, retransmission mechanisms are often used, in which erroneously received segments are retransmitted until successfully received. Since a segment does not need to go right the first time, more aggressive modulation and coding schemes may be used, which support more bits in each segment. This typically increases efficiency, e.g. in terms of being able to support a certain data rate at lower channel quality.

Retransmission mechanisms rely on that a receiver detecting segments in error and notifies the transmitter of this. The transmitter then schedules a retransmission. This has a cost in terms of delay. The time between an initial transmission and a retransmission is often denoted a round-trip time (RTT). During the RTT, while waiting for feedback on whether to retransmit a segment, the transmitter can send other segments if available. If no other segments are available, the transmitter is idle. The latter often occurs in the end of an application packet, when most segments are successfully delivered, and only one or a few are outstanding. The fact that the transmitter is occasionally idle means that when it is active, data needs to be transmitted at a higher data rate than if it could be active all the time. Allowing a large number of retransmissions leads to more round-trips and idle periods, and hence requires higher data rates and higher signal quality requirements.

To control the modulation and coding used, and thereby the probability of retransmissions, a link adaptation mechanism is used. Such a mechanism hence has a trade-off to do between the two effects described above: (i) segmenting the application packet into a small number of larger segments and allowing many retransmissions to increase robustness and thereby lower the required signal quality, and (ii) segmenting the application packet into a larger number of smaller segments, restricting the number of retransmissions to avoid idle periods, and there by lower the signal quality requirement.

A problem is how to do that trade-off for services with application-level delay requirements. A tradeoff between a link adaptation and ARQ mechanism segmenting the application packet into a small number of segments, striving for the maximum number of possible retransmissions is inefficient because of long idle periods and a mechanism segmenting the application packet into a large number of segments, striving for the minimum number of retransmissions is inefficient because of the exclusion of using retransmissions to increase efficiency.

An object of embodiments herein is to improve the performance in a wireless communications network using segmentation of application data packets.

According to an aspect of embodiments herein, the object is achieved by a method performed by a network node. The method is for selecting a number of segments to segment an application data packet. The application data packet is to be transmitted between the network node and a User Equipment, UE, in a wireless communications network. The network node determines (201) a set of possible number of segments. The set of possible number of segments fulfils an application packet delay requirement with a certain probability. Each of the possible numbers of segments corresponds to a different number of retransmissions per segment. For each possible number of segments in the set, the network node determines (202) any one out of: an amount of data in a segment, or a segment data rate. For each possible number of segments in the set, the network node determines (203) a residual segment error probability after the possible number of retransmissions per segment, required to achieve the certain probability to meet the application data packet delay requirement. The network node determines (204) a signal quality requirement for each of the possible number of segments, based on: the amount of data in a segment, or the segment data rate, a number of allowed retransmissions per segment, and the residual segment error probability. The network node then selects (205) the number of segments that fulfils a criterion related to the determined signal quality. The number of segments that fulfils a criterion is selected from the determined set of possible numbers of segments. The determined number of segments will be used to segment the application data packet to be transmitted between the network node and the UE.

According to another aspect of embodiments herein, the object is achieved by a network node configured to select a number of segments to segment an application data packet to be transmitted between the network node and a User Equipment, UE, in a wireless communications network. The network node is further configured to:
determine a set of possible number of segments, fulfilling an application packet delay requirement with a certain probability, wherein each of the possible numbers of segments are adapted to correspond to a different number of retransmissions per segment,
for each possible number of segments in the set,
   determine any one out of: an amount of data in a segment, or a segment data rate, and
   determine a residual segment error probability after the possible number of retransmissions per segment, required to achieve the certain probability to meet the application data packet delay requirement,
   determine a signal quality requirement for each of the possible number of segments, based on,
   the amount of data in a segment, or the segment data rate,
   a number of allowed retransmissions per segment, and
   the residual segment error probability,
from the determined set of possible numbers of segments, select the number of segments that fulfils a criterion related to the signal quality, which determined number of segments will be used to segment the application data packet to be transmitted between the network node and the UE.

In this way, the method enables maximizing or improving coverage and capacity of services with application packet delay requirements.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting an embodiment of a method in a network node.

FIG. 3 is a schematic diagram illustrating different embodiments herein.

FIG. 4 is a schematic diagram illustrating different embodiments herein.

FIG. 5 is a schematic block diagram illustrating embodiments of a network node.

FIG. 6 schematically illustrates a telecommunication network connected via an intermediate network to a host computer.

FIG. 7 is a generalized block diagram of a host computer communicating via a base station with a user equipment over a partially wireless connection.

FIGS. 8-11 are flowcharts illustrating methods implemented in a communication system including a host computer, a base station, and a user equipment.

### DETAILED DESCRIPTION

Examples of embodiments herein provide a way of selecting the target number of segments.

According to some examples of embodiments herein provide a method for finding a number of segments, or equally a target number of segment retransmissions, that with a desired probability meets the application data delay requirement and has the lowest possible required signal quality. This may be performed by determining different segmentation possibilities and characterizing them in terms of number of allowed segment retransmissions, required segment data rates, their requirements on signal quality, and selecting the case with the lowest requirement.

An example of the method performed by a network node may comprise the following steps:
Determining a set of possible segmentation alternatives that can fulfill the application packet delay requirement.
For each segmentation alternative determining the number of segment retransmissions allowed.
For each segmentation alternative, determining the amount of data in a TB, or equivalently the segment data rate.
For each segmentation alternative, also determining the residual error probability, i.e. after retransmissions, required to achieve a desired probability to meet the application data packet delay requirement.
For each segmentation alternative, based on the segment data rate, the number of allowed retransmissions, and the residual error probability, determining the required signal quality.
Selecting the segmentation alternative with the lowest signal quality requirement.

Embodiments herein enable maximizing or improving coverage and capacity of services with application packet delay requirements.

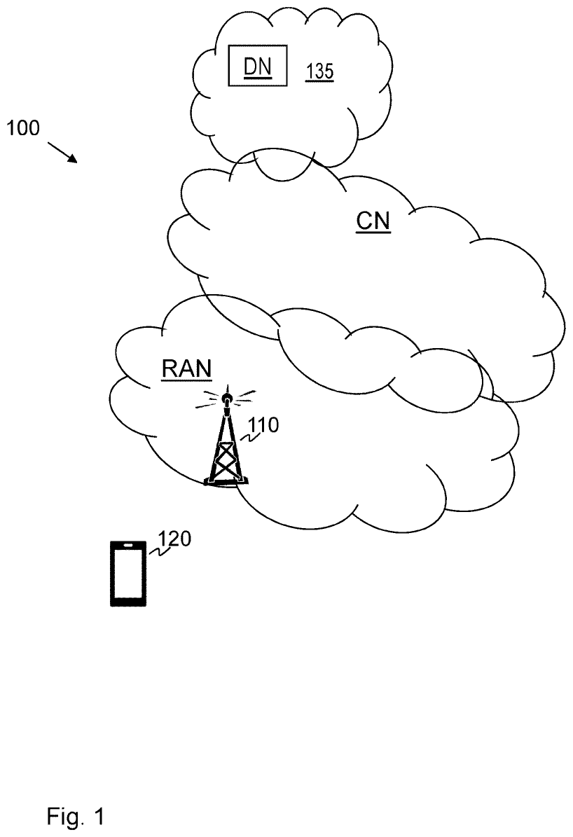

FIG. 1 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes, such as a network node 110, operate in the wireless communications network 100. The network node 110 e.g. provides a number of cells and may use these cells for communicating with UEs such as e.g. a UE 120. The network node 110 may e.g. be a transmission and reception point e.g. a base station, a radio access network node such as a base station, a radio base station, a NodeB, an evolved Node B (eNB, eNodeB, eNode B), an NR/g Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the network node 110 depending e.g. on the radio access technology and terminology used.

UEs operate in the wireless communications network 100, such as e.g. the UE 120. The respective UE 120 may e.g. be an NR device, a mobile station, a wireless terminal, an NB-IoT device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, and a Vehicle-to-Network (V2N) device, a Wi-Fi device, an LTE device and a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

Methods herein may in one aspect be performed by the network node 110. As an alternative, a Distributed Node (DN) and functionality, e.g. comprised in a cloud 135 as shown in FIG. 1, may be used for performing or partly performing the methods of embodiments herein.

A number of embodiments will now be described, some of which may be seen as alternatives, while some may be used in combination.

In some example embodiments of the method provides a way of finding a number of segments, also referred to as a target number of segment retransmissions, that with a desired probability fulfills an application data delay requirement and e.g., has the lowest possible required signal quality. This may e.g., be performed by determining different segmentation possibilities and characterizing them, e.g., in terms of number of allowed segment retransmissions, required segment data rates, their requirements on signal quality, and then selecting the case with the lowest requirement.

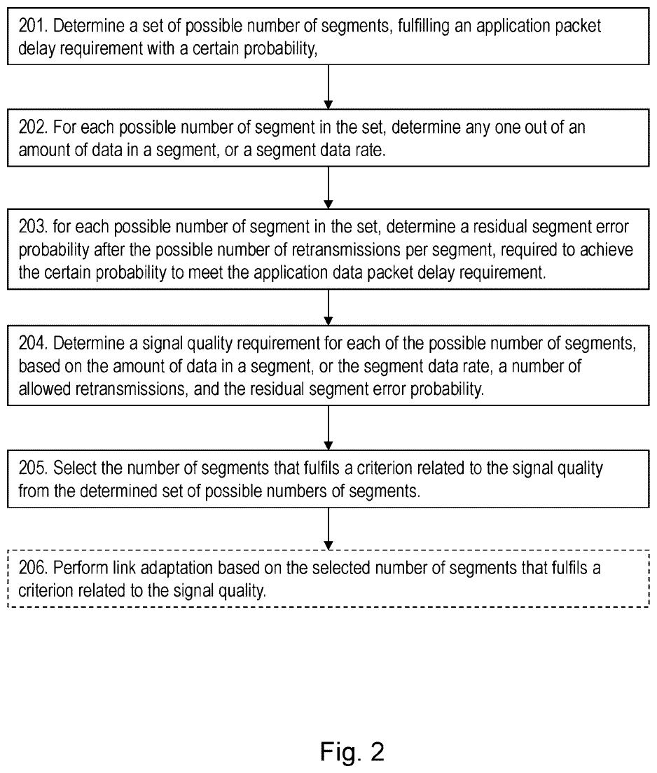

FIG. 2 shows exemplary embodiments of a method performed by the network node 110. The method is for selecting a number of segments to segment an application data packet. An application data packet when used herein, e.g., means an IP packet, a video frame, a voice frame, data describing the pose of a user of extended reality services. Segmenting an application data packet e.g., means to divide the application data packet into smaller subsets of data called segments. The size of the segments is often selected so that they are suitable to transmit over a communication link, e.g., using a desired modulation and coding scheme and occupying the link for a desired duration. The application data packet is to be transmitted between the network node 110 and the UE 120 in the wireless communications network 100. This means that the data packet may be sent from the network node 110 to the UE 120 or from the UE 120 to the network node 110.

The method comprises the following actions, which actions may be taken in any suitable order. Optional actions are referred to as dashed boxes in FIG. 2.

### Action 201

There are different segmentation possibilities that can be segmented into the application data packet, that with a desired probability fulfills an application data delay requirement. These different segmentation possibilities have different possible numbers of segments. The network node determines the different segmentation possibilities and characterizes e.g., in terms of application data delay. A set of possible number of segments when used herein e.g., means the different segmentation possibilities characterized e.g., in terms of respective application data delay.

As input to the method the size of the application data packet, its delay requirement, and a desired probability to meet that delay requirement may be determined by the network node 110. If the network node 110 is a base station, the base station may be made aware of the delay and reliability requirements from the core network, the application, or elsewhere.

The network node 110 determines a set of possible number of segments. The determined set of possible number of segments fulfils an application packet delay requirement with a certain probability. Each of the possible numbers of segments corresponds to a different number of retransmissions per segment.

The set of possible numbers of segments may e.g., comprise all possible numbers of segments from zero segments up to a maximum number of segments.

The determining of the set of possible number of segments that fulfils an application packet delay requirement with a certain probability may be based on Round Trip Time (RTT) measurements.

This will be exemplified and described more in detail below.

### Action 202

For each possible number of segments in the set, the network node 110 determines any one out of an amount of data in a segment, or a segment data rate.

The amount of data in a segment, or a segment data rate will be used as one of the basis for selecting the number of segments below. This is e.g., since it affects the required signal quality. A larger segment, or equally a higher data rate when the segment is sent in a given time, requires a higher signal quality, and vice versa. The amount of data in a segment may be determined by the amount of data in the application packet divided by the number of segments. The segment data rate may be determined in the same way and further dividing by the transmission duration of the segment.

### Action 203

For each possible number of segments in the set, the network node 110 determines a residual segment error probability after the possible number of retransmissions per segment, required to achieve the certain probability to meet the application data packet delay requirement. A residual segment error probability when used herein e.g., means the probability that the segment is not successfully decoded by the receiver after having done up to the allowed number of transmissions. The residual segment error probability will also be used one of the basis for selecting the number of segments below. This is since the residual error probability affects the required signal quality. A lower residual error probability requires a higher signal quality and vice versa.

The determining of the residual segment error probability may be based on an application packet error rate requirement and/or the number of segments an application packet is segmented into. The application packet error rate requirement may be established by receiving such information from other network nodes or the application, e.g. via Quality of Service parameters. The number of segments the application packet is segmented into may be calculated based on the number of possible segments in the set, the RTT measurements, a segment duration, and the application packet delay requirement.

This will be exemplified and described more in detail below.

### Action 204

The network node 110 determines a signal quality requirement for each of the possible number of segments, based on:
the amount of data in a segment, or the segment data rate,
a number of allowed retransmissions, and
the residual segment error probability.

### Action 205

The network node 110 selects the number of segments that fulfils a criterion related to the signal quality. The number of segments that fulfils a criterion are selected from the determined set of possible numbers of segments. The determined number of segments will be used to segment the application data packet to be transmitted between the network node 110 and the UE 120.

The criterion to be fulfilled may e.g., be related to the number of segments requiring the lowest signal quality, any number of segments that require a signal quality below a certain channel quality, or the maximum or minimum number of segments that require a signal quality below a certain channel quality.

The number of segments that fulfils a criterion related to the signal quality may be represented by the number of segments requiring the lowest signal quality.

### Action 206

In some embodiments, the network node 110 performs link adaptation based on the selected number of segments that fulfils a criterion related to the signal quality. This is an advantage since the number of segments determines the amount of data in each segment, which in turn determines what combinations of modulation and coding schemes can be used to send the segment in a given duration, e.g., a so-called Transmission Time Interval (TTI).

In this way there is a direct coupling between segmentation and link adaptation.

Embodiments herein such as the embodiments mentioned above will now be further described and exemplified. The text below is applicable to and may be combined with any suitable embodiment described above.

In the description below, the maximum (Nmax) and other possible numbers of allowed transmissions (n) are first determined, and based on that the number of segments (n_S) is calculated. Alternatively, it is possible to first determine possible numbers of segments(S), and based on that calculate corresponding numbers of allowed transmissions (n_S).

In some more detail, some examples of embodiments herein may comprise the steps below. As input, it is assumed the size of the application data packet, its delay requirement, and a desired probability to meet that delay requirement are determined by the network node 110.
The network node 110 calculates the maximum number of segment transmission attempts while meeting the application packet delay budget, Nmax. This relates to and may be combined with Action 201 described above.
For each possible number of segment transmission attempts in the set, n=1, . . . , Nmax, the network node 110 may determine the number of segments n_S the application packet is segmented in. The term n_S is used to indicate that n is based on S. The number of segments n_S corresponds to a number allowed segment transmissions (n), and will be used for calculating the segment size and together with the probability to meet the application data packet delay requirement be used for determining the residual segment error probability. It should be noted that the order of these two first steps may be swapped. This relates to and may be combined with Action 203 described above.

In some embodiments, the determining Nmax may come first. Then the determining of residual error rate and segment size and/or data rate may be swapped.

Further, it is started with determining possible numbers of allowed transmissions (n), and based on that calculate the number of segments (n_S) etc. It may equally well start with the number of segments (n_S), and based on that, calculate the number of allowed transmissions (n). That would give rise to some not so useful cases where the number of segments is reduced, but not enough to allow for additional transmission attempts. However, it should be noted that such an order would also work.
For each possible number of segment transmission attempts in the set, n=1, . . . , Nmax, the network node 110 calculates the segment data rate Rn needed to get the packet through within the delay budget. This relates to and may be combined with Action 202 described above.
For each possible number of segment transmission attempts in the set, n=1, . . . , Nmax, the network node 110 determines the residual segment error rate, after retransmissions required to meet the application packet delay requirement with the desired probability, also referred to as the residual segment error probability. This relates to and may be combined with Action 203 described above.
For each possible number of segment transmission attempts in the set, the network node 110 calculates the Signal-to-Noise Ratio (SNR) n, that is the SNR required to reach the segment data rate Rn with the associated residual error rate. This relates to and may be combined with Action 204 described above.
The network node 110 selects n*=arg min{SNRn]. This means that the network node 110 selects the number of segments n_S*that fulfils a criterion related to the signal quality, from the determined set of possible numbers of segments. In this example the number of segments that fulfils a criterion related to the signal quality is represented by the number of segments requiring the lowest signal quality. This relates to and may be combined with Action 205 described above.
The network node 110 may then use n* as an input to link adaptation, or equivalently n_S*as an input to segmentation. This relates to and may be combined with Action 206 described above.

Following these steps, an example of a basic setting will be described.

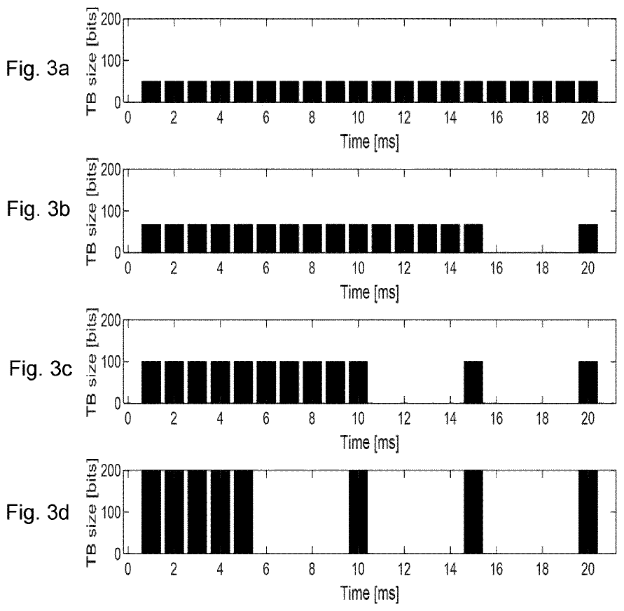

Assume an application data packet of 1000 bits with a delay requirement of 20 ms, which we target to fulfill with 99% probability. It is segmented into segments that take 1 ms to transmit. The size of the segment depends on the modulation and coding scheme used. The round-trip time is 5 ms. See FIGS. 3a-d.

The application packet may be segmented into:
n_S=20 segments of size 50 bits and has no time for retransmissions (n=1). See FIG. 3a.
n_S=15 segments of size 67 bits, and has time for one retransmission (n=2)*. See FIG. 3b.
n_S=10 segments of size 100 bits, and has time for two retransmissions (n=3)*. See FIG. 3c.
n_S=5 segments of size 200 bits and has time for three retransmissions (n=4)*. See FIG. 3d.

*) Retransmissions of the last segment, which is the one that determines the overall delay.

The different alternatives are illustrated in FIG. 3a-d. Note that when more retransmissions are allowed, the idle time increases, and more data needs to be carried in each segment, denoted TB in FIGS. 3a-d.

The segment data rates may be calculated as the segment size divided by the segment duration. In this simple example it is also assumed that the segment errors are independent, so that the residual error probability requirement of a segment Psegment is referred to as Psegment=1−(1−Pap)\hat{ }(1/Ntb), where Pap is the desired probability of reaching the application packet delay requirement, and Nsegment is the number of segments the application packet is segmented into. The data rates and residual error rates become:

$$50 kbps and Psegment = 0.0005 for no retransmissions$$

$$67 kbps and Psegment = 0.0007 for one retransmission$$

$$100 kbps and Psegment = 0.001 for two retransmissions$$

$$200 kbps and Psegment = 0.002 for three retransmissions$$

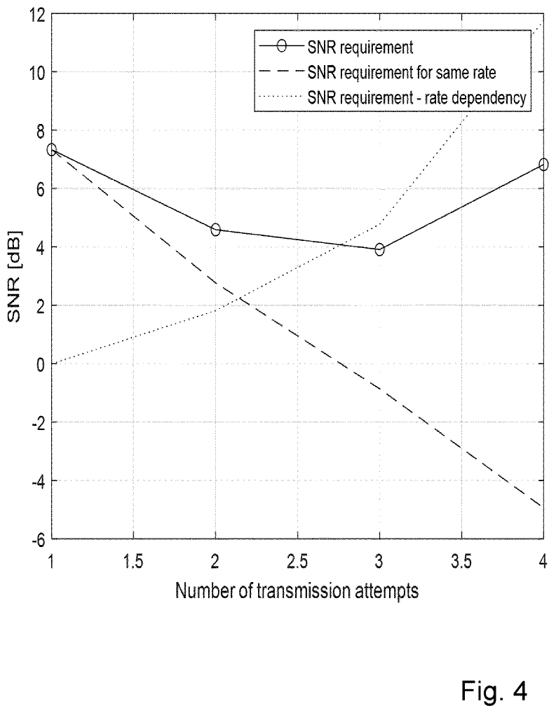

These data rates, residual error rates, and allowed numbers of transmissions will result in different signal quality requirements. In this basic example to illustrate an example of the principle, the required SNRs have been calculated by the network node 110 assuming uncoded Binary Phase-Shift Keying (BPSK) modulation over an Additive White Gaussian Noise (AWGN) channel, using the formula Pe=0.5*erfc (sqrt (SNR)). It is further assumed that segment errors are independent, so that the error probability requirement on an individual segment transmission is Psegment_individual=Ptb\hat{ }(1/Ntx), where Ntx is the number of transmissions allowed. FIG. 4 shows the resulting SNR requirements for the different alternatives, solid line with o-markers. It Is seen that the SNR requirement varies between the alternative number of transmissions allowed and has a minimum of 4 dB for allowing three transmission attempts, n=3, n_S=10, or two retransmissions. This would hence be the result of the method.

Also included in FIG. 4, in the dashed line, is the SNR requirement assuming the same data rate requirement for all the alternatives, which falls with increasing number of transmissions, and in the dotted line, the SNR cost for supporting the increased rate required when allowing more retransmissions, which increases with an increased number of transmissions. The provided method according to example embodiments herein, finds the number of transmission attempts with the best combination of these two effects, i.e. the one with the lowest SNR requirement.

Some more details will be given below, e.g., in terms of how the required data may be obtained. It is here assumed that the method is executed in the network node 110, e.g. a base station as mentioned above. The input to the method, i.e. the size of the application data packet, its delay requirement, and a desired probability to meet that delay requirement, may be obtained from QoS mechanisms via higher protocol layers.
The network node 110 calculates the maximum number of segment transmission attempts while meeting the application packet delay budget, Nmax, also referred to as the number of allowed retransmissions. This can be done if the RTT is known. The RTT can be configured by higher layers, or estimated by the method based on historical data.
For each possible number of segments in the set, n=1, . . . , Nmax, determine the number of segments n_S the application packet is segmented in. It should be noted that the order of these two first steps may be swapped. This relates to and may be combined with Action 201 described above. If this step is done first, all alternatives may be considered from n_S=1 segment containing the whole application packet to the case where n_S=n_S Max for n=1. Some of those would result in the same n. Among those, only the alternative with the largest n_S may be kept for simplicity, as that would result in the smallest segments, which for the same n typically would be the best alternative. In the simple example above, e.g. n_S=13 segments may be tested, but that would not allow more retransmissions than n_S=15 and hence likely be worse.
For each possible number of segments in the set, n=1, . . . , Nmax, c the network node 110 calculates the segment data rate Rn needed to get the packet through within the delay budget. This may be done based on application packet size and Nmax from the previous step. This relates to and may be combined with Action 202 described above.
For each possible number of segments in the set, n=1, . . . , Nmax, the network node 110 determine the residual segment error rate after retransmissions required to meet the application packet delay requirement with the desired probability, also referred to as the residual segment error probability. This may be be done based on the application packet error rate requirement, available from higher layers, and the number of segments the application packet is segmented into, which is may be calculated based on n, the RTT, the segment duration and the application packet delay requirement. This relates to and may be combined with Action 203 described above.
For each possible number of segments in the set, the network node 110 calculates the signal quality requirement, e.g., SNRn, the SNR required to reach the segment data rate Rn with the associated residual error rate. This information may be provided to the method as a table mapping SNR and R, or estimated by the method based on historical data. This relates to and may be combined with Action 204 described above.
The network node 110 then selects the number of segments that fulfils a criterion related to the signal quality, e.g., by selecting the number of segments n=arg min {SNRn] from the determined set of possible numbers of segments. This is internal to the method. No new data required. This relates to and may be combined with Action 205 described above.
The network node 110 may then use the selected number of segments n as an input to link adaptation. This may be done by an interface towards the link adaptation function, where a target number of transmission attempts is provided to the link adaptation function. This relates to and may be combined with Action 206 described above.

To perform the method actions above, the network node 110 is configured to select a number of segments to segment an application data packet to be transmitted between the network node 110 and the UE 120 in the wireless communications network 100.

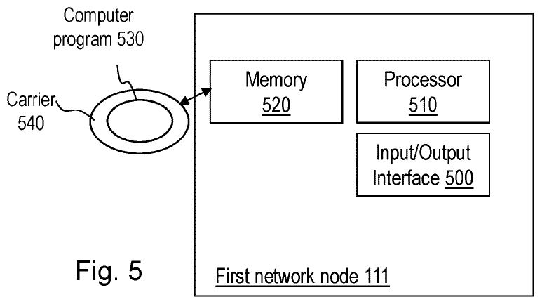

The network node 110 may comprise an arrangement depicted in FIG. 5 The network node 110 may comprise an input and output interface 500 configured to communicate in the wireless communications network 100, e.g., with the UE 120. The input and output interface 500 may comprise a wireless receiver not shown, and a wireless transmitter not shown.

The network node 110 is further configured to determine a set of possible number of segments, fulfilling an application packet delay requirement with a certain probability. Each of the possible numbers of segments are adapted to correspond to a different number of retransmissions per segment.

The network node 110 is further configured to, for each possible number of segments in the set, determine any one out of: an amount of data in a segment, or a segment data rate.

The network node 110 is further configured to, for each possible number of segments in the set, determine a residual segment error probability after the possible number of retransmissions per segment, required to achieve the certain probability to meet the application data packet delay requirement.

The network node 110 is further configured to determine a signal quality requirement for each of the possible number of segments, based on the amount of data in a segment, or the segment data rate, a number of allowed retransmissions per segment, and the residual segment error probability.

The network node 110 is further configured to, from the determined set of possible numbers of segments, select the number of segments that fulfils a criterion related to the signal quality. The determined number of segments will be used to segment the application data packet to be transmitted between the network node 110 and the UE 120.

The network node 110 may further be configured to perform the link adaptation based on the selected number of segments that fulfils a criterion related to the signal quality.

The number of segments that fulfils a criterion related to the signal quality may be adapted to be represented by the number of segments requiring the lowest signal quality.

The set of possible numbers of segments may be adapted to comprise all possible numbers of segments from zero segments up to a maximum number of segments.

In some embodiments, the network node 110 is further being configured to determine the set of possible number of segments fulfilling an application packet delay requirement with a certain probability based on RTT measurements.

The network node 110 may further be configured to determine the residual segment error probability based on an application packet error rate requirement and the number of segments an application packet is segmented into.

The number of segments the application packet is segmented into may be adapted to be calculated based on the number of possible segments in the set, the RTT measurements, a segment duration, and the application packet delay requirement.

The embodiments herein may be implemented through a respective processor or one or more processors, such as the processor 510 of a processing circuitry in the network node 110 depicted in FIG. 5, together with computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 520 comprising one or more memory units. The memory 520 comprises instructions executable by the processor 510 in the network node 110. The memory 520 is arranged to be used to store e.g., information, determined information, indications, data, configurations, iterations, communication data, and applications to perform the methods herein when being executed in the respective first network node 111 and second network node 112.

In some embodiments, a computer program 530 comprises instructions, which when executed by the at least one processor 510, cause the at least one processor of the network node 110 to perform the actions above.

In some embodiments, a carrier 540 comprises the computer program 530, wherein the carrier 540 is one of an electronic signal, an optical signal, an electromagnetic signal, a magnetic signal, an electric signal, a radio signal, a microwave signal, or a computer-readable storage medium.

Those skilled in the art will appreciate that units in the network node 110 described above may refer to a combination of analog and digital circuits, and/or one or more processors configured with software and/or firmware, e.g. stored in the network node 110, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a System-on-a-Chip (SoC).

With reference to FIG. 6, in accordance with an embodiment, a communication system includes a telecommunication network 3210, such as a 3GPP-type cellular network, e.g. wireless communications network 100, which comprises an access network 3211, such as a radio access network, and a core network 3214. The access network 3211 comprises a plurality of base stations 3212a, 3212b, 3212c, e.g., the BS 110, such as AP STAs NBs, eNBs, gNBs or other types of wireless access points, each defining a corresponding coverage area 3213a, 3213b, 3213c. Each base station 3212a, 3212b, 3212c, e.g. radio network nodes 141,142, is connectable to the core network 3214 over a wired or wireless connection 3215. A first user equipment (UE), e.g. the UE 120, such as a Non-AP STA 3291 located in coverage area 3213c is configured to wirelessly connect to, or be paged by, the corresponding base station 3212c, e.g., the network node 110. A second UE 3292, e.g., any of the one or more second UEs 122, such as a Non-AP STA in coverage area 3213a is wirelessly connectable to the corresponding base station 3212a, e.g., the network node 110. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 6 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

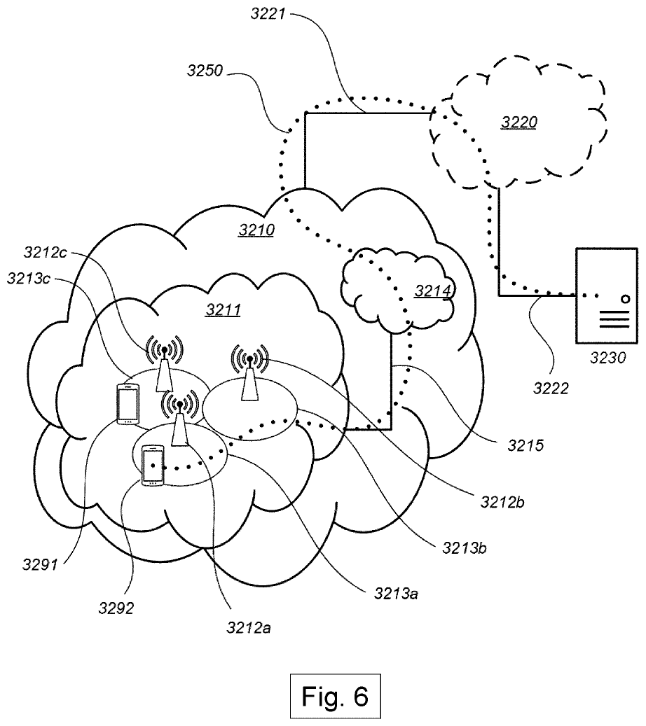

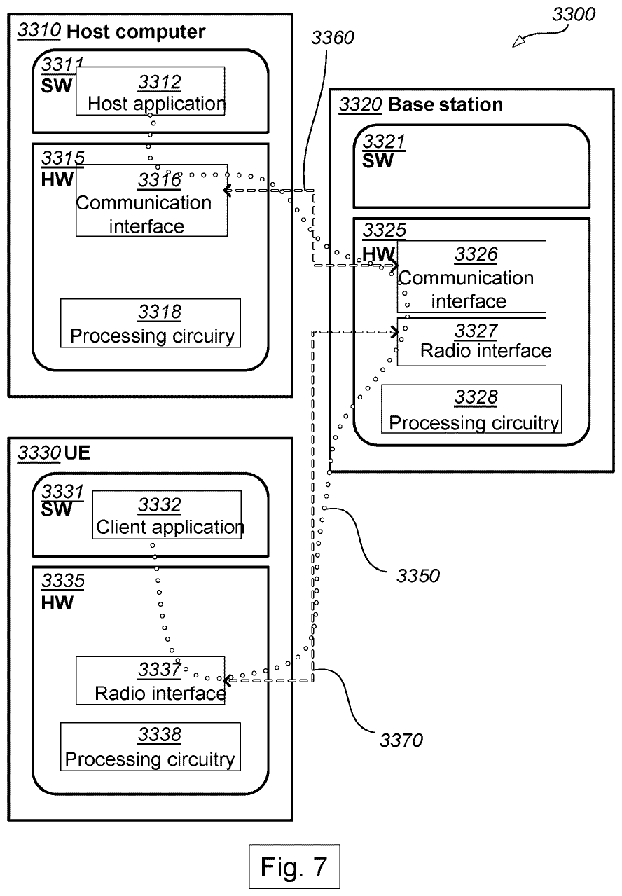

Example implementations, in accordance with an embodiment, of the UE, base station and host computer discussed in the preceding paragraphs will now be described with reference to FIG. 7. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 7) served by the base station 3320. The communication interface 3326 may be configured to facilitate a connection 3360 to the host computer 3310. The connection 3360 may be direct or it may pass through a core network (not shown in FIG. 7) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 6 may be identical to the host computer 3230, one of the base stations 3212a, 3212b, 3212c and one of the UEs 3291, 3292 of FIG. 6, respectively. This is to say, the inner workings of these entities may be as shown in FIG. 7 and independently, the surrounding network topology may be that of FIG. 6.

In FIG. 7, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as e.g. the applicable corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

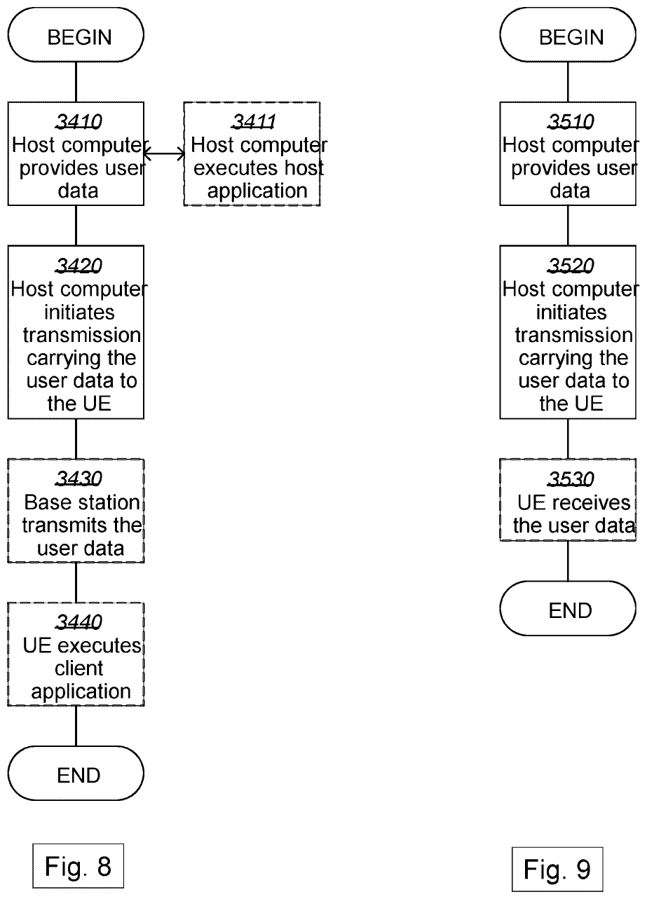

FIG. 8 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 8 will be included in this section. In a first Step 3410 of the method, the host computer provides user data. In an optional sub Step 3411 of the first Step 3410, the host computer provides the user data by executing a host application. In a second Step 3420, the host computer initiates a transmission carrying the user data to the UE. In an optional third Step 3430, the base station transmits to the UE the user data which was carried in the transmission that the host computer initiated, in accordance with the teachings of the embodiments described throughout this disclosure. In an optional fourth Step 3440, the UE executes a client application associated with the host application executed by the host computer.

FIG. 9 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 9 will be included in this section. In a first Step 3510 of the method, the host computer provides user data. In an optional sub step (not shown) the host computer provides the user data by executing a host application. In a second Step 3520, the host computer initiates a transmission carrying the user data to the UE. The transmission may pass via the base station, in accordance with the teachings of the embodiments described throughout this disclosure. In an optional third Step 3530, the UE receives the user data carried in the transmission.

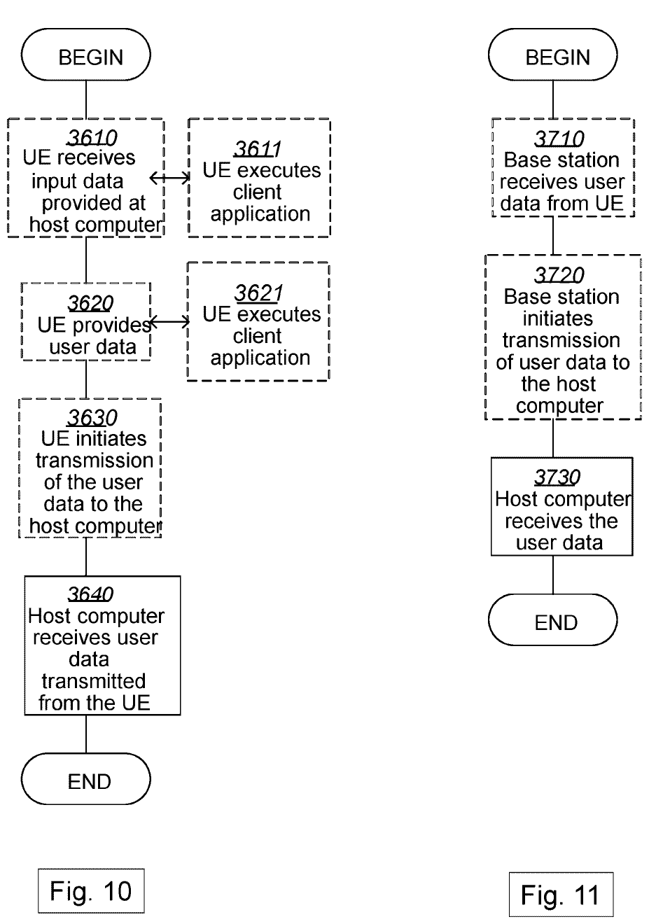

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 10 will be included in this section. In an optional first Step 3610 of the method, the UE receives input data provided by the host computer. Additionally or alternatively, in an optional second Step 3620, the UE provides user data. In an optional sub Step 3621 of the second Step 3620, the UE provides the user data by executing a client application. In a further optional sub Step 3611 of the first Step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub Step 3630, transmission of the user data to the host computer. In a fourth Step 3640 of the method, the host computer receives the user data transmitted from the UE, in accordance with the teachings of the embodiments described throughout this disclosure.

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 11 will be included in this section. In an optional first Step 3710 of the method, in accordance with the teachings of the embodiments described throughout this disclosure, the base station receives user data from the UE. In an optional second Step 3720, the base station initiates transmission of the received user data to the host computer. In a third Step 3730, the host computer receives the user data carried in the transmission initiated by the base station.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

1. A method performed by a network node for selecting a number of segments to segment an application data packet to be transmitted between the network node and a User Equipment, UE, in a wireless communications network, the method comprising:
determining a set of possible number of segments, fulfilling an application packet delay requirement with a certain probability, wherein each of the possible numbers of segments, corresponds to a different number of retransmissions per segment,
for each possible number of segments in the set:
determining any one out of: an amount of data in a segment, or a segment data rate,
determining a residual segment error probability after the possible number of retransmissions per segment, required to achieve the certain probability to meet the application data packet delay requirement, and
determining a signal quality requirement for each of the possible number of segments, based on:
the amount of data in a segment, or the segment data rate,
a number of allowed retransmissions, and
the residual segment error probability,
from the determined set of possible numbers of segments, selecting the number of segments that fulfils a criterion related to the signal quality, which determined number of segments will be used to segment the application data packet to be transmitted between the network node and the UE.

2. The method according to claim 1, further comprising:
performing link adaptation based on the selected number of segments that fulfils a criterion related to the signal quality.

3. The method according to claim 1, wherein the number of segments that fulfils a criterion related to the signal quality is represented by the number of segments requiring the lowest signal quality.

4. The method according to claim 1, wherein the set of possible numbers of segments comprises: all possible numbers of segments from zero segments up to a maximum number of segments.

5. The method according to claim 1, wherein the determining of the set of possible number of segments, fulfilling an application packet delay requirement with a certain probability is based on Round Trip Time, RTT measurements.

6. The method according to claim 1, wherein the determining of the residual segment error probability is based on:
an application packet error rate requirement and the number of segments an application packet is segmented into.

7. The method according to claim 6, wherein the number of segments the application packet is segmented into is calculated based on:
the number of possible segments in the set, the RTT measurements, a segment duration, and the application packet delay requirement.

8. A computer program comprising instructions, which when executed by a processor, causes the processor to perform actions according to claim 1.

9. (canceled)

10. A network node configured to select a number of segments to segment an application data packet to be transmitted between the network node and a User Equipment, UE, in a wireless communications network, wherein the network node further is configured to:
determine a set of possible number of segments, fulfilling an application packet delay requirement with a certain probability, wherein each of the possible numbers of segments are adapted to correspond to a different number of retransmissions per segment,
for each possible number of segments in the set:
determine any one out of: an amount of data in a segment, or a segment data rate,
determine a residual segment error probability after the possible number of retransmissions per segment, required to achieve the certain probability to meet the application data packet delay requirement, and
determine a signal quality requirement for each of the possible number of segments, based on:
the amount of data in a segment, or the segment data rate,
a number of allowed retransmissions, and
the residual segment error probability,
from the determined set of possible numbers of segments, select the number of segments that fulfils a criterion related to the signal quality, which determined number of segments will be used to segment the application data packet to be transmitted between the network node and the UE.

11. The network node according to claim 10, further being configured to:
perform the link adaptation based on the selected number of segments that fulfils a criterion related to the signal quality.

12. The network node according to claim 10, wherein the number of segments that fulfils a criterion related to the signal quality is adapted to be represented by the number of segments requiring the lowest signal quality.

13. The network node according to claim 19, wherein the set of possible numbers of segments is adapted to comprise: all possible numbers of segments from zero segments up to a maximum number of segments.

14. The network node according to claim 10, further being configured to determine the set of possible number of segments fulfilling an application packet delay requirement with a certain probability based on Round Trip Time, RTT measurements.

15. The network node according to claim 10, further being configured to determine the residual segment error probability based on:
an application packet error rate requirement and the number of segments an application packet is segmented into.

16. The network node according to claim 15, wherein the number of segments the application packet is segmented into is adapted to be calculated based on:
the number of possible segments in the set, the RTT measurements, a segment duration, and the application packet delay requirement.
